(19) United States
(12) Patent Application Publication
(10) Pub. No.: US 2018/0068400 A1
(43) Pub. Date: Mar. 8, 2018

(54) Property Listing System and Method

(71) Applicant: Steven B. Homes, Inc., Oklahoma City, OK (US)

(72) Inventor: Steven Hamilton Burris, Yukon, OK (US)

(73) Assignee: Steven B. Homes, Inc.

(21) Appl. No.: 15/258,534

(22) Filed: Sep. 7, 2016

(51) Int. Cl. G06Q 50/16; H04W 4/02

(52) U.S. Cl. CPC G06Q 50/16; G06F 17/30867; H04W 4/021

(57) ABSTRACT

Systems and methods for providing a way to generate listings for a property for sale including automatically determining a current location of a user device, automatically accessing property information of at least one property associated with the current location of the user device, generating a property listing responsive to a user selecting an indicator associated with the at least one property, the property listing containing the accessed property information and a listing agent information, the listing agent information being user information associated with the user. The systems and methods disclosed provide a way for the user to automatically disseminate property listings and updates regarding the property listings within a predetermined group of registered users who may, for instance, be associated with a real estate agency. The property listings may be a standard listing, a for sale by owner (FSBO) property listing, and/or an upcoming listing of a standard property listing.

### BACKGROUND

Real estate marketing and sales is largely facilitated by real estate agents who are generally members of a large network of similar professionals. Real estate agents use their specialized skills to market a property, help sellers navigate state specific laws corresponding to the property location, and understand the financial implications to participants of a real estate transaction. To perform these services, real estate agents generally charge 6% of the sale price of the home. Generally, it is the seller that pays the fee as part of closing. In a transaction where there is a listing agent and a buyer's agent, the listing agent and the buyer's agent will generally split the 6% fee.

For a variety of reasons, some sellers choose to list their property for sale themselves and without the assistance of a real estate agency. These listings are referred to as for sale by owner (FSBO) homes. Although listing a property for sale by an owner may potentially save the seller from having to pay a commission to the real estate agency, according to the 2015 National Association of REALTORS® Profile of Home Buyers and Sellers the most difficult tasks reported by FSBO sellers were, understanding and performing paperwork, getting the right price, preparing/fixing up the home for sale, selling within the planned length of time, and having enough time to devote to all aspects of the sale. In addition, the same poll reports the typical FSBO home sold for $210,000 compared to $249,000 for agent-assisted home sales. Not having access to the specialized knowledge and tools a real estate agent has available, nor the ability to leverage their large network of like professionals, limits market exposure of FSBO homes to prospective buyers and may result in a longer listing time and/or a lower sales price.

Regardless of their reason for listing their home FSBO, in some cases FSBO sellers are willing to deal with the real estate agent of a potential buyer as long as the buyer's agent agrees to accept a lower percentage fee, usually 3% of the sale price of the home. However, this generally requires the buyer's agent to have “stumbled” upon the property as it has not been marketed in the traditional way.

Therefore, a need exists for a system and method of making FSBO property listing information more readily available while allowing the seller to leverage the knowledge, skills, and network of a real estate agent to aid in the selling of a property for an agreed upon fee. It is to such an improved system and method that the presently disclosed inventive concepts are directed.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a diagrammatic view of hardware forming an exemplary embodiment of a system for listing real estate for sale constructed in accordance with the present disclosure.

FIG. 2 is a diagrammatic view of an exemplary user device for use in the system for listing real estate for sale illustrated in FIG. 1.

FIG. 3 is a diagrammatic view of an exemplary embodiment of a host system for use in the system for listing real estate for sale illustrated in FIG. 1.

FIG. 4 is an illustration of an exemplary login screen in accordance with some embodiments of the present disclosure.

FIG. 5 is an illustration of an exemplary home screen in accordance with some embodiments of the present disclosure.

FIG. 6 is an illustration of an exemplary capture screen in accordance with some embodiments of the present disclosure.

FIG. 7 is an illustration of an exemplary property information input screen in accordance with some embodiments of the present disclosure.

FIG. 8 is an illustration of an exemplary property search screen in accordance with some embodiments of the present disclosure.

FIG. 9 is an illustration of an exemplary search results screen in accordance with some embodiments of the present disclosure.

FIG. 10 is an illustration of an exemplary listed property screen in accordance with some embodiments of the present disclosure.

FIG. 11 is an illustration of an exemplary confirmation screen in accordance with some embodiments of the present disclosure.

FIG. 12 is an illustration of an exemplary property data screen in accordance with some embodiments of the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

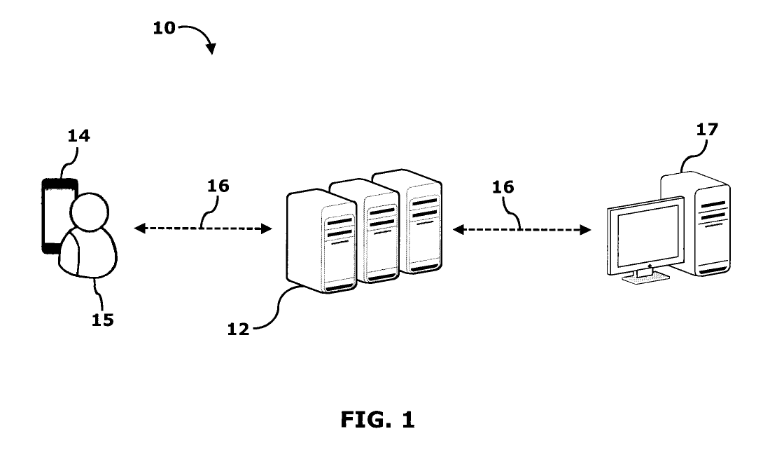

Referring now to the Figures, and in particular to FIG. 1, shown therein is a diagrammatic view of hardware forming an exemplary embodiment of a system 10 for listing real estate for sale constructed in accordance with the present disclosure.

As discussed above, regardless of their reason for listing their home FSBO, in some cases FSBO sellers are willing to deal with the real estate agent of a potential buyer as long as the buyer's agent agrees to accept a lower percentage fee, usually 3% of the sale price of the home. In accordance with the present disclosure, it has been found that FSBO real estate listings can be created by a real estate agency by approaching FSBO seller(s) and creating a private FSBO real estate listing in which the private FSBO real estate listing is solely made available to appropriate personnel, e.g., real estate agents, within a defined group of one or more real estate agencies. The system 10 is configured to create FSBO real estate listings (e.g., in an automated manner) and automatically track and disseminate information about the FSBO real estate listings to a predetermined group of registered users within a predefined group of one or more real estate agency, and preferably without disseminating the information about the FSBO real estate listings to users (registered or unregistered) outside of the predefined group. As will be discussed below, this can be implemented by having embodiments of the system 10 designed for a single real estate agency, or multiple real estate agencies. With respect to multiple real estate agencies, the system 10 may include a user profile for each registered user and/or a real estate agency profile for each real estate agency serviced by the system 10. The user profile may include an associated real estate agency and/or the real estate agency profile may include associated users. In these examples, the system 10 is a special purpose computer system programmed to solve the problems associated with effectively using FSBO real estate listings by automating the process of creating, disseminating, and tracking the status of the FSBO real estate listings.

The system 10 is provided with at least one host system 12 (hereinafter “host system 12”), a plurality of user devices 14 (hereinafter “user device 14”), and a network 16. In some embodiments, the system 10 may include at least one external system 17 (hereinafter “external system 17”) for use by an administrator to add, delete, or modify user information, provide management reporting, or manage property or seller information. The system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors as depicted in FIG. 1, for example.

The host system 12 of the system 10 may include a single processor or multiple processors working together or independently to perform a task. In some embodiments, the host system 12 may be partially or completely network-based or cloud based. The host system 12 may or may not be located in single physical location. Additionally, multiple host systems 12 may or may not necessarily be located in a single physical location.

In some embodiments, the system 10 may be distributed, and include at least one host system 12 communicating with one or more user device 14 via the network 16. As used herein, the terms “network-based,” “cloud-based,” and any variations thereof, are intended to include the provision of configurable computational resources on demand via interfacing with a computer and/or computer network, with software and/or data at least partially located on a computer and/or computer network.

In some embodiments, the network 16 may be the Internet and/or other network. For example, if the network 16 is the Internet, a primary user interface of the system 10 may be delivered through a series of web pages or private internal web pages of a company or corporation, which may be written in hypertext markup language. It should be noted that the primary user interface of the system 10 may be another type of interface including, but not limited to, a Windows-based application, a tablet based application, a mobile web interface, and/or the like.

The network 16 may be almost any type of network. For example, in some embodiments, the network 16 may be a version of an Internet network (e.g., exist in a TCP/IP-based network). It is conceivable that in the near future, embodiments within the present disclosure may use more advanced networking technologies.

In some embodiments, the external system 17 may optionally communicate with the host system 12. For example, in one embodiment of the system 10, the external system 17 may supply data transmissions via the network 16 to the host system 12 regarding real-time or substantially real-time events (e.g., user updates, photographic or illustration image updates, and/or property information updates). Data transmission may be through any type of communication including, but not limited to, speech, visuals, signals, textual, and/or the like. Events may include, for example, data transmissions regarding user messages or updates from a real estate agent, for example, initiated via the external system 17. It should be noted that the external system 17 may be the same type and construction as the user device 14.

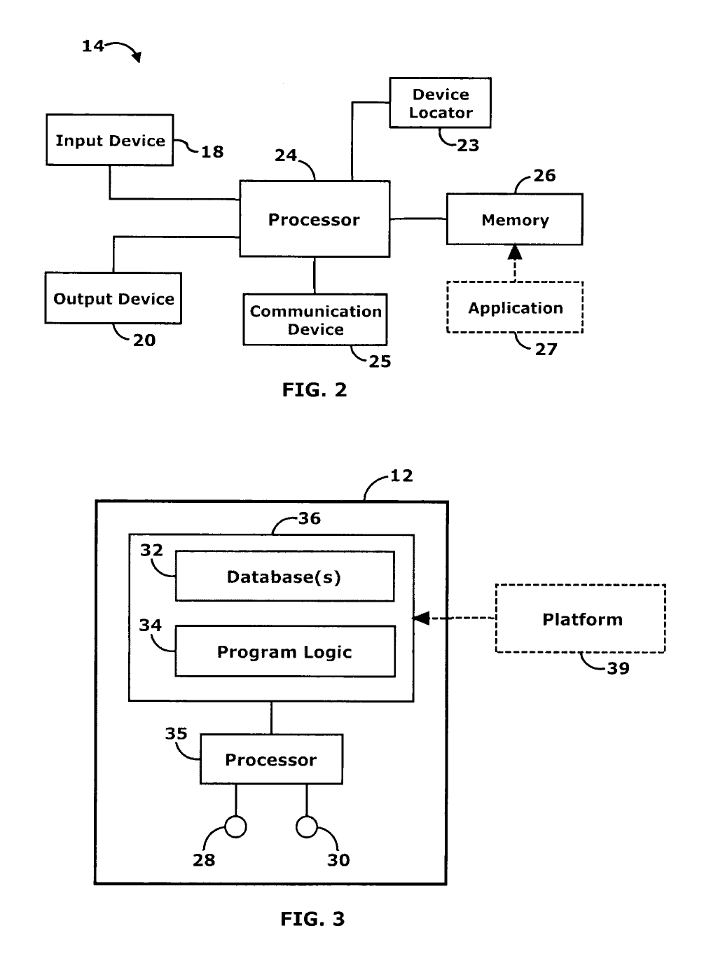

As shown in FIG. 2, the one or more user devices 14 of the system 10 may include, but are not limited to implementation as a personal computer, a cellular telephone, a smart phone, a network-capable television set, a tablet, a laptop computer, a desktop computer, a network-capable handheld device, a server, a digital video recorder, a wearable network-capable device, and/or the like.

In some embodiments, the user device 14 may include one or more input devices 18 (hereinafter “input device 18”), one or more output devices 20 (hereinafter “output device 20”), a device locator 23, one or more processors 24 (hereinafter “processor 24”), one or more communication devices 25 (hereinafter “communication device 25”) capable of interfacing with the network 16, one or more non-transitory memory 26 (hereinafter “memory 26”) storing processor executable code and/or software application(s), for example including, a web browser capable of accessing a website and/or communicating information and/or data over a wireless or wired network (e.g., network 16), and/or the like. The memory 26 may also store an application 27 that, when executed by the processor 24 causes the user device 14 to automatically and without user intervention collect predefined property information based on the user's current location as determined by the device locator 23 to allow the user to quickly and accurately add a new FSBO real estate listing with minimal input from an FSBO seller. In some embodiments, the application 27 is programmed to cause the processor 24 to provide a capture information screen (FIG. 6) to the output device 20, and to receive information from the user via the input device 18. Such information can be stored either temporarily and/or permanently in the memory 26 and/or transmitted to the host system 12 via the network 16 using the communication device 25.

Embodiments of the system 10 may also be modified to use any user device 14 or future developed devices capable of communicating with the host system 12 via the network 16.

The device locator 23 may be capable of determining the position of the user device 14. For example, implementations of the device locator 23 may include, but are not limited to, a Global Positioning System (GPS) chip, software based device triangulation methods, network-based location methods such as cell tower triangulation or trilateration, the use of known-location wireless local area network (WLAN) access points using the practice known as “wardriving”, a hybrid positioning system combining two or more of the technologies listed above, or any future developed system or method of locating a device such as the user device 14.

The input device 18 may be capable of receiving information input from the user and/or processor 24, and transmitting such information to other components of the user device 14 and/or the network 16. The input device 18 may include, but are not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The output device 20 may be capable of outputting information in a form perceivable by the user and/or processor 24. For example, implementations of the output device 20 may include, but are not limited to, a computer monitor, a screen, a touchscreen, a speaker, a website, a television set, a smart phone, a PDA, a cell phone, a fax machine, a printer, a laptop computer, combinations thereof, and the like, for example. It is to be understood that in some exemplary embodiments, the input device 18 and the output device 20 may be implemented as a single device, such as, for example, a touchscreen of a computer, a tablet, or a smartphone. It is to be further understood that as used herein the term user is not limited to a human being, and may comprise, a computer, a server, a website, a processor, a network interface, a human, a user terminal, a virtual computer, combinations thereof, and/or the like, for example.

The host system 12 may be capable of interfacing and/or communicating with the user device 14 and the external system 17 via the network 16. For example, the host system 12 may be configured to interface by exchanging signals (e.g., analog, digital, optical, and/or the like) via one or more ports (e.g., physical ports or virtual ports) using a network protocol, for example. Additionally, each host system 12 may be configured to interface and/or communicate with other host systems 12 directly and/or via the network 16, such as by exchanging signals (e.g., analog, digital, optical, and/or the like) via one or more ports.

The network 16 may permit bi-directional communication of information and/or data between the host system 12, the user device 14, and/or the external system 17. The network 16 may interface with the host system 12, the user device 14, and/or the external system 17 in a variety of ways. For example, in some embodiments, the network 16 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 16 may be implemented as the World Wide Web (or Internet), a local area network (LAN), a wide area network (WAN), a metropolitan network, a 4G network, a satellite network, a radio network, an optical network, a cable network, a public switch telephone network, an Ethernet network, combinations thereof, and the like, for example. Additionally, the network 16 may use a variety of network protocols to permit bi-directional interface and/or communication of data and/or information between the host system 12, the user device 14 and/or the external system 17.

Referring now to FIG. 3, shown therein is a diagrammatic view of an exemplary embodiment of the host system 12. In the illustrated embodiment, the host system 12 is provided with one or more databases 32 (hereinafter “database 32”), program logic 34, and one or more processors 35 (hereinafter “processor 35”). The program logic 34 and the database 32 are stored on non-transitory computer readable storage memory 36 (hereinafter “memory 36”) accessible by the processor 35 of the host system 12. It should be noted that as used herein, program logic 34 is another term for instructions which can be executed by the processor 24 or the processor 35. The database 32 can be a relational database or a non-relational database. Examples of such databases comprise, DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The database 32 can be centralized or distributed across multiple systems.

In some embodiments, the host system 12 may comprise one or more processors 35 working together, or independently to, execute processor executable code stored on the memory 36. Additionally, each host system 12 may include at least one input device 28 (hereinafter “input device 28”) and at least one output device 30 (hereinafter “output device 30”). Each element of the host system 12 may be partially or completely network-based or cloud-based, and may or may not be located in a single physical location.

The processor 35 may be implemented as a single processor or multiple processors working together, or independently, to execute the program logic 34 as described herein. It is to be understood, that in certain embodiments using more than one processor 35, the processors 35 may be located remotely from one another, located in the same location, or comprising a unitary multi-core processor. The processors 35 may be capable of reading and/or executing processor executable code and/or capable of creating, manipulating, retrieving, altering, and/or storing data structures into the memory 36.

Exemplary embodiments of the processor 35 may be include, but are not limited to, a digital signal processor (DSP), a central processing unit (CPU), a field programmable gate array (FPGA), a microprocessor, a multi-core processor, combinations, thereof, and/or the like, for example. The processor 35 may be capable of communicating with the memory 36 via a path (e.g., data bus). The processor 35 may be capable of communicating with the input device 28 and/or the output device 30.

The processor 35 may be further capable of interfacing and/or communicating with the user device 14 and/or the external system 17 via the network 16. For example, the processor 35 may be capable of communicating via the network 16 by exchanging signals (e.g., analog, digital, optical, and/or the like) via one or more ports (e.g., physical or virtual ports) using a network protocol to provide updated information to the application 27 executed on the user device 14 such as, for instance, predefined property information such as county assessment information for a property at or near the user's current location.

The memory 36 may be capable of storing processor executable code. Additionally, the memory 36 may be implemented as a conventional non-transitory memory, such as for example, random access memory (RAM), CD-ROM, a hard drive, a solid state drive, a flash drive, a memory card, a DVD-ROM, a disk, an optical drive, combinations thereof, and/or the like, for example.

In some embodiments, the memory 36 may be located in the same physical location as the host system 12, and/or one or more memory 36 may be located remotely from the host system 12. For example, the memory 36 may be located remotely from the host system 12 and communicate with the processor 35 via the network 16. Additionally, when more than one memory 36 is used, a first memory 36 may be located in the same physical location as the processor 35, and additional memory 36 may be located in a location physically remote from the processor 35. Additionally, the memory 36 may be implemented as a “cloud” non-transitory computer readable storage memory (i.e., one or more memory 36 may be partially or completely based on or accessed using the network 16).

The input device 28 of the host system 12 may transmit data to the processor 35 and may be similar to the input device 18 of the user device 14. The input device 28 may be located in the same physical location as the processor 35, or located remotely and/or partially or completely network-based. The output device 30 of the host system 12 may transmit information from the processor 35 to a user, and may be similar to the output device 20 of the user device 14. The output device 30 may be located with the processor 24, or located remotely and/or partially or completely network-based.

The memory 36 may store processor executable code and/or information comprising the database 32 and program logic 34. In some embodiments, the processor executable code may be stored as a data structure, such as the database 32 and/or data table, for example, or in non-data structure format such as in a non-compiled text file.

As illustrated in FIGS. 4-12, the system 10 for listing FSBO real estate for sale may include the application 27 executed by the processor 24 of the user device 14 that is capable of communicating with the host system 12 via the network 16. The system 10 may include a separate program, application or “app”, or a widget, each of which may correspond to instructions stored in the memory 26 of the user device 14 for execution by the processor 24 of the user device 14. Alternately, the system 10 may include instructions stored in the memory 36 of the host system 12 for execution by the processor 35 of the host system 12 with results sent via the network 16 to be displayed on the output device 20 of the user device 14.

The instructions of the application 27, when executed by the processor 24 of the user device 14, cause the user device 14 to perform certain tasks. For example, such tasks may include displaying content such as a login screen 40, a home screen 42, a capture screen 44, a property information input screen 46, a property search screen 50, a search results screen 52, a listed property screen 54, a confirmation screen 56, and a property data screen 58. As illustrated in FIGS. 4-8, the login screen 40, the home screen 42, the capture screen 44, the property information screen 46, the property search screen 50, the search results screen 52, the listed property screen 54, the confirmation screen 56, and the property data screen 58 are shown as such screens may appear on the output device 20 of the user device 14, where the user device 14 is a smart phone or tablet such as an Apple® iPhone® or iPad®. The application 27 may be implemented for use on other types of user devices 14 including, but not limited to, other mobile devices, personal computers, or laptop computers, with appropriate storage and processing capacity and internet or network connectivity. The user of the system 10 may interact via user interface implementations of the user device 14 such as, for instance, by using the touchscreen of the Apple® iPhone® or iPad®. In some embodiments of the system 10, certain viewable screens of the application 27 may be designed to automatically switch from portrait to landscape presentation on the output device 20 of the user device 14 depending on the current orientation of the user device 14 being utilized. It should be noted that such functionality is optional, and has no adverse impact on the functionality of the application 27.

It should also be noted that where necessary, desirable, or both, property intake questions of the system 10 may be administered manually, for instance, by a real estate agent and then entered into the system 10 via the input device 28 of the host system 12.

Referring now to FIG. 4, an exemplary login screen 40 of the application 27 is shown. The login screen 40 of the application 27 may have fields designed for input from the user associated with the user device 14, for instance, a username field 60, and a password field 62. In some embodiments of the application 27, the login screen 40 may also include a password retrieval function in the event a user loses or cannot remember their password to access the application 27. In the embodiment shown in FIG. 4, the password retrieval function may be initiated by selecting a forgot password button 64 on the login screen 40. Once the user has input their username in the username field 60 and their password in the password field 62, the user may select a sign in button 66 to access the application 27. An alternative login function (not shown) may also be present on the login screen 40, which provides login functionality and allows the user to login to the system 10 via other authentication or verification methods such as through the social networks Linkedin.com, or Facebook.com. Some embodiments of the system 10 may also allow a new user to register their information from the login screen 40 of the application 27.

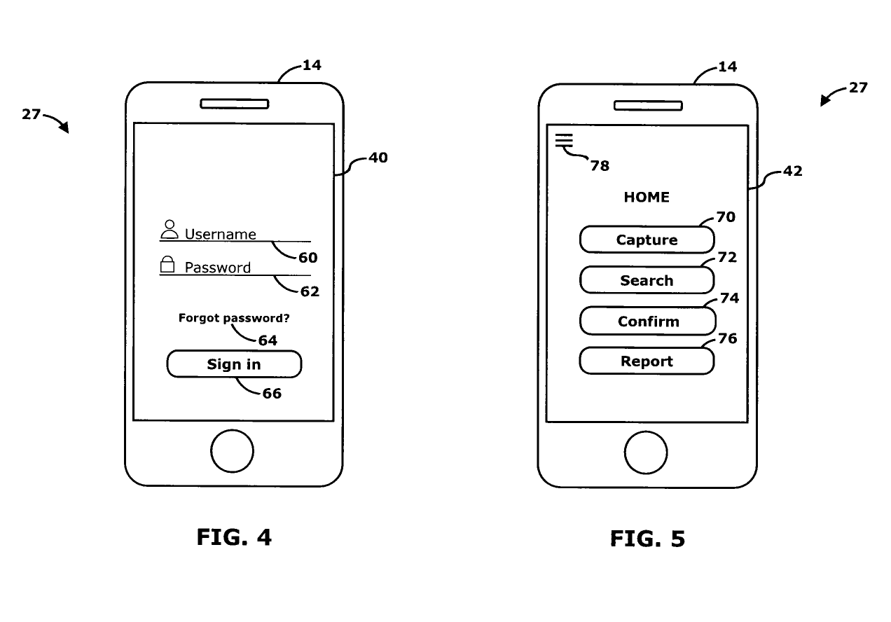

After the user logs in, the logic may branch from the login screen 40 to the home screen 42, for example. Shown in FIG. 5 is an exemplary home screen 42 of the application 27. The home screen 42 may be provided with a capture button 70, a search button 72, a confirm button 74, a report button 76, and a settings button 78. By selecting the capture button 70, or other suitably assigned or programmed button or interactivity option (such as swiping) available on the user device 14, the user may begin a property information capture process to create a new FSBO real estate listing, for instance. Each of these respective buttons allows the user to access the various aspects and screens of the application 27.

In one embodiment of the application 27, the settings button 78 allows the user to personalize the look, feel, and function of the application 27, however, it will be understood that such functionality is optional, and has no adverse impact on the functionality of the application 27.

FIG. 6 illustrates an exemplary capture screen 44 of the application 27. The capture screen 44 is provided with a GPS coordinates section 80, a property information section 82, listed property markers 84 (only one of which is designated in FIG. 6), a find property button 86, and a menu button 88 all displayed as overlays on a map 89 showing a geographical region surrounding the user and the user device 14.

When the user accesses the capture screen 44 such as, for instance, by selecting the capture button 70 on the home screen 40, the application 27 is programmed to automatically and without user intervention begin a process of creating a new FSBO real estate listing. When the capture button 70 is selected, the logic obtains a current location of the user device 14 using, for instance, the device locator 23 of the user device 14 and then branches to show the capture screen 44 as shown in FIG. 6. In some embodiments, the application 27 then displays the current location of the user device 14 in the GPS coordinates section 80 overlaid on the map 89 of the capture screen 44 to identify the FSBO property to be included in the new FSBO real estate listing. The application 27 may display the current location in a number of ways. By way of non-limiting example, in FIG. 6 the current location is shown in decimal degrees in the GPS coordinates section 80. It should be understood, however, that the application 27 may show the current location in other ways including, but not limited to, an address, degrees, minutes, and seconds, or simply as a mark indicated on the map 89 similar to the property marker 84 illustrated in FIG. 6.

In some embodiments, the application 27 may use the current location to identify the FSBO property, and then access predefined property information stored, for instance, on the host system 12 associated with the current location to populate the application 27 with the predefined property information describing the FSBO property. In other embodiments, the application 27 may be programmed to automatically remotely access electronically available predefined property information associated with the current location stored, for instance, on an assessor system (not shown) or other third-party system (not shown). In one such embodiment, the application 27 may be programmed, for instance, to access multiple systems to load predefined property information. For instance, the application 27 may use the current location of the user device 14 as determined by the device locator 23 to automatically access the physical address of a property from the third party system which may be a Google application program interface (API), for instance, and then use the physical address to access property information associated with the physical address stored on the assessor system. In another embodiment, the application 27 may send the current location to the host system 12 via the network 16 and the host system 12 may remotely access electronically available predefined property information associated with the current location stored, for instance, on the assessor system. These examples are provided by way of non-limiting example and it should be understood that the system 10 may be appropriately configured to interface with electronic property records in whatever form they may be stored to allow the user to access and/or retrieve the predefined property information.

The predefined property information associated with the current location may be displayed in the property information section 82 of the capture screen 44. As illustrated in FIG. 6, the predefined property information displayed in the property information section 82 may include, but is not limited to, an assessed value and an address. It should be noted that the predefined property information may include more information about the FSBO property such as, for instance, a square footage or further description of the FSBO property, however, the predefined property information section 82 may be programmed to display only predetermined portions of the predefined property information as shown in FIG. 6. By displaying at least some of the predefined property information, the application 27 provides the user with a way to verify that the FSBO real estate listing will include the correct information for the desired FSBO property. If the predefined property information is correct, the user may select the associated property by selecting the property information section 82, for instance, by touching the property information section 82 on the output device 20 of the user device 14 where the output device 20 is a touchscreen device.

If the predefined property information listed in the property information section 82 is not correct, in one embodiment of the application 27 the user may select a different property by selecting the find property button 86. In some embodiments of the application 27, when the find property button 86 is selected, the application 27 is configured to automatically access predefined property information for other properties closely associated with the current location. For instance, in a densely populated area there may be several homes within a relatively small area. In that case, the application 27 may be configured to automatically determine and display the next closest property in the property information section 82 of the capture screen 44. For the purposes of the present disclosure, a property is considered “closely associated with the current location” when the FSBO property is between 1 meter and 100 meters from the current location of the user device 14 as determined using the device locator 23.

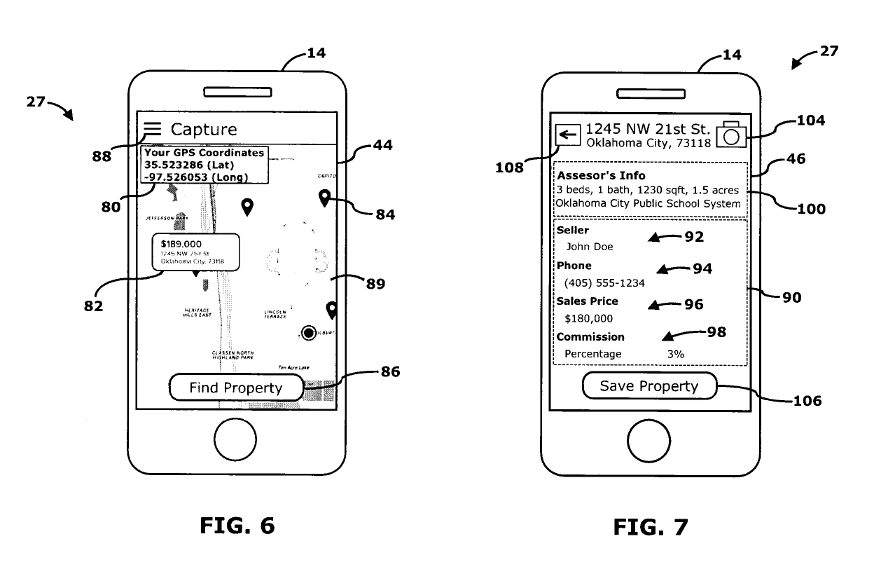

In another embodiment, selecting the find property button 86 of the capture screen 44 causes the application 27 to display a search field (not shown) that will accept input from the user. The user may then input an address or other identifying coordinates into the search field using the input device 18 of the user device 14 to access predefined property information as described above. Once an address is entered, the application 27 may be configured to display the map 89 of an area surrounding the address as shown in FIG. 6. In addition, the application 27 may be configured to display at least a portion of the predefined property information associated with the input address in the property information section 82, such as location, square footage, and a description of the FSBO property as shown in FIG. 7.

In another embodiment of the application 27, the user may select a different property by indicating the property on the map 89 using the input device 18 of the user device 14, or, where the output device 20 of the user device 14 is a touchscreen, the user may indicate the property on the map 89 by touching the output device 20. In one such embodiment, the application 27 may be programmed to place a property marker 84 on the current location and the user may indicate a different property by dragging or otherwise moving the property marker 84 to a new property. Once the new property is selected, the application 27 may be programmed to automatically determine and display predefined property information associated with the selected property as described herein.

In another embodiment, the user selecting the find property button 86 of the capture screen 44 will cause the application 27 to display a list (not shown) of properties closely associated with the current location, the list being configured to allow the user to select a desired FSBO property from the list.

The listed property markers 84 may indicate FSBO and non-FSBO properties currently listed for sale in the system 10. A list of FSBO properties currently listed for sale may be stored, for instance, in the database 32 on the host system 12. The list of non-FSBO properties may be stored, for instance in the database 32 on the host system 12, or in another database such as a database associated with a property listing service known as the Multiple Listing Service (MLS). In some embodiments of the system 10, the list of properties currently listed for sale may include both standard real estate listings (i.e. the seller contracted with a real estate agent or real estate agency to list the property for sale), and FSBO real estate listings (i.e. where the seller listed the property for sale themselves but has agreed to pay a predetermined fee to a real estate agent or real estate agency who finds a buyer for the FSBO property). In another embodiment of the system 10, the list of properties currently listed for sale may include only FSBO real estate listings.

In one embodiment of the system 10 which is configured to include both FSBO and standard real estate listings, the application 27 and/or an administrative tool (not shown) accessible on the external system 17 may be programmed to allow the user 15 to input standard real estate listings before they are available to non-users of the system 10, for instance, on the MLS. These listings will be referred to herein as upcoming listings. In this way, the system 10 allows standard real estate listing information to be made available to users 15 of the system 10 before they are made available to non-users. By way of example, when a real estate agent or real estate agency contracts with a new client to list their property for sale, there can be an amount of time between when the contract is signed and when the property is listed for sale, for instance, on the MLS. In that case, the real estate agent, who is a user 15 of the system 10, may add the property as an upcoming listing in the system 10 enabling other users 15 of the system 10 to access the property information before it is available to non-users. Thus, the users 15 of the system 10 are able to present the property to potential buyers before non-users know it is available for sale.

To add the upcoming listing to the system 10, the user 15 may use the methods described herein for adding a FSBO property, thus allowing the user 15 to quickly add the upcoming listing, for instance, when the user 15 is meeting with the seller to sign the contract. In such an embodiment, the system 10 may be provided with a way to designate the property as an upcoming listing. For instance, the application 27 may be provided with an upcoming listing button (not shown) or other appropriately programmed mechanism on the capture screen 44 or the property information input screen 46. It should be noted that the above examples have been provided for the purposes of illustration only and the system 10 may be provided with other ways to designate the property listing type.

Once the upcoming listing has been made available to non-users such as on the MLS, the system 10 may be programmed to automatically and without user intervention replace the upcoming listing with the MLS listing and display it as such in the system 10.

The listed property markers 84 may be provided in different colors, shapes, or sizes designed to indicate a type and/or a current status of the listing. For instance, by way of non-limiting example, a green colored property marker 84 may indicate that the property is currently listed for sale by owner. A red colored property marker 84 may indicate that the property is currently listed for sale but under contract. A yellow colored property marker 84 may indicate that the property is currently listed for sale by owner but the seller has been unresponsive to requests to view the property. A blue property marker 84 may indicate a property that is listed for sale on a standard property listing application such as, for instance, the Multiple Listing Service (MLS). It should be noted that other colors and/or status indications may be used. In another embodiment, all of the property markers 84 may be the same color and/or shape.

To navigate the application 27 from the capture screen 44, the user may select the menu button 88 or other appropriately programmed button or other mechanism. The menu button 88 of the capture screen 44 may be programmed to display a group of navigation buttons (not shown), for instance, in a pop-up menu or list.

Once an identification of the FSBO property is entered into the application 27, and the property information section 82 is updated, the application 27 loads the property information input screen 46 shown in FIG. 7. The property information input screen 46 is provided with an input section 90, a property information section 100, an address section 102, an image button 104, a save property button 106, and a navigation button such as back button 108.

The input section 90 is designed to accept input from the user in input fields such as, for instance, a seller field 92, a seller phone field 94, a sales price field 96, and a commission field 98. The fields 92-98 of the input section 90 may be associated with appropriate fields in the database 32 accessible by the host system 12 of the system 10. The fields 92-98 of the input section 90 may be, for instance, configured as text input fields, drop-down lists, or have appropriately programmed toggle buttons (not shown) that allow the user to input or change the desired information. For instance, by way of non-limiting example, in some embodiments the commission field 98 may be displayed with 3% being the default text. Toggle buttons (not shown) may be provided that allow the user to increase or decrease the 3% to the desired amount depending on terms negotiated with the seller listed in the seller field 92.

The property information section 100 and the address section 102 of the property information input screen 46 display the predefined property information for the property selected on the capture screen 44. As shown in FIG. 7, the property information section 100 may include, for instance, information such as number of bedrooms, number of bathrooms, building square footage, total property size, and what public school system the property is in. It should be noted, however, that the property information section 100 may display more or less information so long as the user is able to confirm that the property they are entering information for is correct.

The user may choose to add an image of the property by selecting the image button 104. If the user device 14 is provided with a camera (not shown), the image button 104 may be programmed to cause the user device 14 to access the camera to capture an image of the property. In another embodiment, the image button 104 may be programmed to allow the user to browse to an image already saved in the memory 26 of the user device 14. In another embodiment, the application 27 may be programmed to automatically retrieve an image of the property when downloading the property information, for instance, from the assessor system. In such an embodiment, the image button 104 may be programmed to allow the user to change the image of the property if desired.

In some embodiments, the application 27 may be programmed to facilitate a contractual obligation between the real estate agency or real estate agent that the user is associated with and the seller of the FSBO property. In this instance, logic may be used to supply a real estate listing contract (automatically populated with the FSBO property information) to the seller and receive an indication of acceptance of the real estate listing contract from the seller. This can be accomplished in a variety of manners, such as by emailing / texting the real estate listing contract to the seller and receiving a signal (such as a return email or text) indicating acceptance of the contract. During face to face meetings between the user and the seller, the application 27 may be programmed to display the real estate listing contract on the user device 14 such that the seller can review the real estate listing contract and enter a seller's acceptance such as by clicking on a predefined field.

Once information has been entered into the input section 90 and (if applicable) the real estate listing contract has been accepted by the seller, users may transmit the information via the network 16 from communication device 25 of the user device 14 to the host system 12 for registration in the database 32 as a new FSBO real estate listing, by selecting, for instance, the save property button 106 or other appropriately programmed selectable indicator, such as a button or mechanism associated with the at least one property. In this manner, the user device 14 enables generation of the property listing responsive to the user selecting the selectable indicator associated with the at least one property. The host system 12 may enable generation of the property listing responsive to the user selecting the selectable indicator associated with the at least one property by receiving an appropriate signal from the user device 14 and then generating a signal to cause the property listing to be generated within the database 32. However, if there is no connection via the network 16, the data may be temporarily stored internally in the memory 26 of the user device 14 until a connection to the network 16 can be established to enable generation of the property listing as discussed above. In another embodiment of the system 10, the application 27 may transmit the information to the host system 12 dynamically in real time as it is entered by the user to enable generation of the property listing as discussed above. In still another embodiment of the system 10, the application 27 may transmit the information to the host system 12 at predetermined intervals to enable generation of the property listing as discussed above.

In some embodiments of the system 10, when the new FSBO real estate listing is saved in the database 32, the host system 12 may be programmed to automatically and without user intervention send a message such as, for instance, a text message to a predetermined group of registered users within a predefined group of one or more real estate agency, and preferably without disseminating the information about the FSBO real estate listings to users (registered or unregistered) outside of the predefined group. For example, the message can be sent to all real estate agents associated with the user who input the new FSBO real estate listing and/or the real estate agency whom the user works with. The message may include, for instance, the information input in the seller field 92, the address section 102, the seller phone field 94, the sales price field 96, the commission field 98, and the property information section 100, or combinations thereof. In one embodiment of the system 10, the real estate agents associated with the user who input the new FSBO real estate listing may include, for instance, all real estate agents in the same real estate agency as the user. To determine which real estate agents are associated with the same real estate agency, in one embodiment, the system 10 may be programmed to automatically associate all users who register for the application 27 listing the same real estate agency as their employer. In another embodiment, the system 10 may be programmed to automatically associate all users who register to use the application 27 using an email address ending in the same domain name. In another embodiment, the system 10 may allow the user to select real estate agents with whom they want to be associated. It should be noted that these examples are provided for the purposes of illustration only and are not intended to limit the ways in which the system 10 may associate real estate agents with a user. Further, an administrator using the external system 17 and/or one of the user devices 14 may determine and set up the predetermined group of registered users and/or the predefined group of one or more real estate agency.

To navigate the application 27 from the property information input screen 46, the user may select the back button 108 or other appropriately programmed button or other mechanism. As illustrated in FIG. 7, the back button 108 may be programmed to cause the application 27 to return to a prior screen. However, it should be noted that in some embodiments of the application 27, the property information input screen 46 may be provided with the menu button 88 instead of the back button 108. In such an embodiment, the menu button 88 may be programmed as described above.

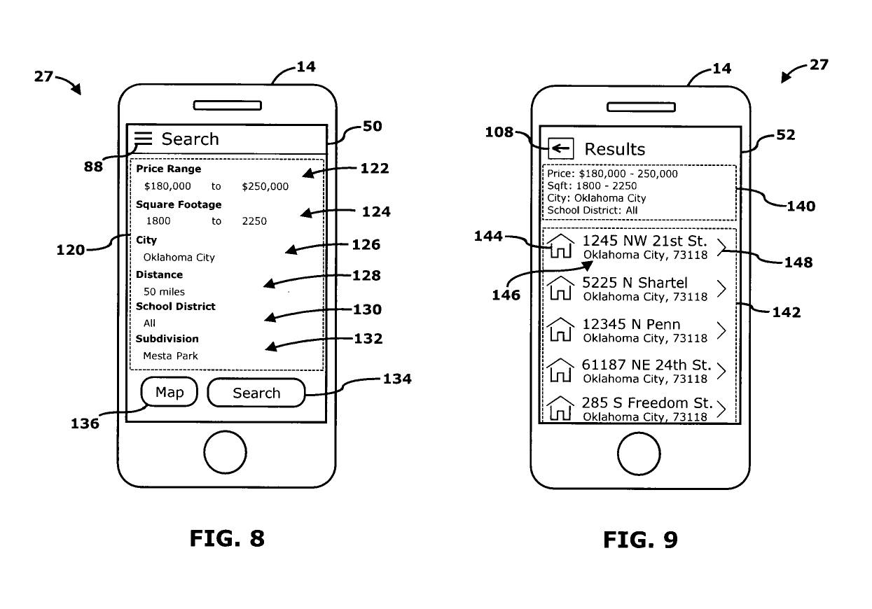

As illustrated in FIG. 8, the application 27 may include the property search screen 50 to assist the user in locating FSBO real estate listing(s) and/or non-FSBO real estate listing(s). The property search screen 50 may be provided with a search input section 120 configured to receive input from the user in fields including, for instance, price range 122, square footage 124, city 126, distance 128, school district 130, and subdivision 132. The fields 122-132 of the search input section 120 may correspond to appropriate fields in the database 32. Once the user has input information into one or more of the fields 122-132 of the search input section 120, the user may select a search button 134, or other appropriately programmed mechanism configured to cause the application 27 to send the input information via the network 16 to the host system 12 where the system 10 may use the input information to find a subset of the properties listed for sale that are stored in the database 32 of the host system 12 or another database associated with the system 10.

As an alternate method of searching, the map button 136 of the property search screen 50 may be programmed to display the map 89, for instance, of a city or an area within a predetermined distance of the current location of the user device 14 as determined by the device locator 23 of the user device 14. The map 89 may be similar to the one shown in FIG. 6 and have similar property markers 84 corresponding to available properties. In one embodiment, the user may select the property marker 84 associated with a house they would like more information on. In this way, the user may find properties listed for sale without necessarily having to know any identifying information about the property such as, for instance, the address. For instance, if the user who is a real estate agent is driving through a neighborhood with a client and the client says they like the neighborhood, the user may then use the application 27 to pull up the map 89 of the area based on their current location as determined by the device locator 23 of the user device 14 and select property markers 84 to get more information about properties for sale in and near that neighborhood. In another embodiment, the application 27 may be configured to allow the user to select a desired section of the map by, for instance, dragging a box on the map 89 using the touch screen of the user device 14. In such an embodiment, the application 27 may be programmed to return a list of properties listed for sale that fall within the selected section similar to the one shown in FIG. 9.

Shown in FIG. 9 is the search results screen 52 showing results of a search using the illustrative data input into the fields 122-132 of the search input section 120 of the property search screen 50. As shown in FIG. 9, the search results screen 52 is provided with a search criteria section 140 which is programmed to show at least a portion of the information input into the fields 122-132 of the search input section 120 of the property search screen 50.

A results section 142 of the search results screen 52 is programmed to receive the subset of the listed properties from the host system 12 obtained in response to the application 27 sending the input information via the network 16 to the host system 12. As shown in FIG. 9, the results section 142 may show the subset of listed properties as an organized list with each listed property having an image button 144, an address section 146, and an information button 148. The organized list may be organized in many different ways. For instance, by way of non-limiting example, the list may be organized by how closely the property matches the search criteria, the distance from the current location of the user device 14, or grouped by city or zip code.

In one embodiment of the application 27, the image button 144 of the results section 142 may be programmed to display a larger version of the image associated with the listed property when selected by the user. For instance, to display the larger image, the application 27 may be programmed to open a pop-up screen (not shown) containing the larger image. In another embodiment, the image button 144 may be configured to cause the application 27 to open the listed property screen 54 showing more information about the listed property.

The information button 148 of the results section 142 may be programmed to cause the application 27 to open the listed property screen 54 showing more information about the listed property.

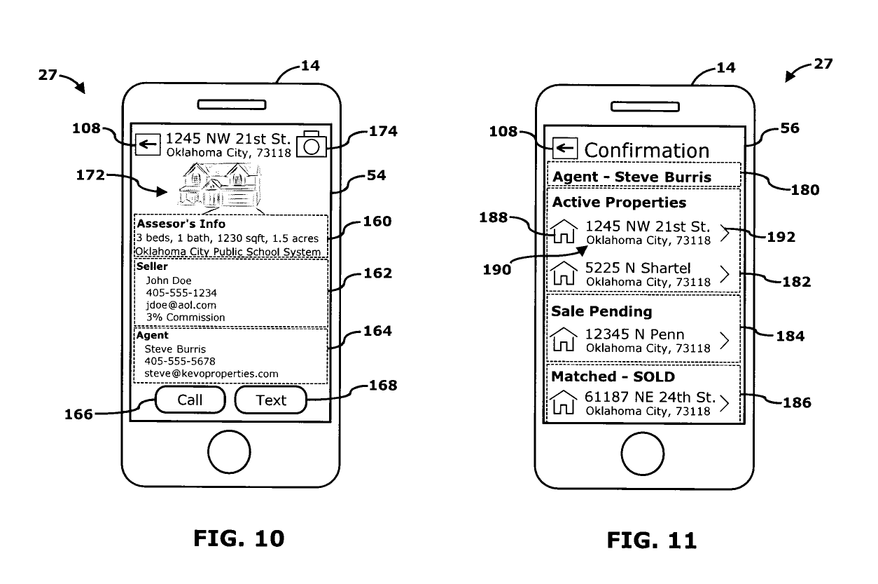

As shown in FIG. 10, the listed property screen 54 may be provided with a property information section 160, a seller information section 162, an agent information section 164, a call button 166, a text button 168, an address section 170, a property image 172, an image button 174, and a back button 108.

The property information section 160 may be programmed to display the property information stored in the database 32 associated with the displayed FSBO real estate listing. The property information may include, but is not limited to, the predefined property information retrieved from the assessor system and/or information input by the user, for instance, using the property information input screen 46 of the application 27.

The seller information section 162 may be programmed to display the seller information stored in the database 32 associated with the listed property. The seller information may include, but is not limited to, information input by the user, for instance, using the property information input screen 46 of the application 27. For instance, as shown in FIG. 10 the seller information includes the seller's name, phone number, email address, and the commission the seller has agreed to pay. In some embodiments, the seller information section 162 may include other information such as a contact preference indicative of how the seller would prefer to be contacted (i.e. phone call, text, email, etc.) or different preferred contact methods for different times of days. For instance, a seller may only want to be contacted via text message during weekdays but will accept phone calls in the evening or on weekends.

The agent information section 164 may be programmed to display listing agent information stored in the database 32 associated with the listed property. The listing agent information may include, but is not limited to, information associated with the user who originally input the FSBO real estate listing, for instance, using the property information input screen 46 of the application 27. In such an embodiment, the system 10 may automatically associate user information input when the user registered to use the application 27. For instance, in one embodiment of the system 10, when the user registers to use the application 27 they may be required to input identifying information such as, for instance, their name, real estate agency affiliation, address, cell phone number, real estate agency phone number, and email address. Once registered, when the user inputs a new property in the application 27, the user's information is automatically associated with the new FSBO real estate listing in the database 32 as the listing agent and may be displayed in the agent information section 164 of the listed property screen 54.

The call button 166 and the text button 168 may be programmed to cause the user device 14 to perform specific tasks. For instance, when the user selects the call button 166, the application 27 may be programmed to cause the user device 14 to automatically dial a phone number associated with the call button 166. The text button 168 may be programmed to cause the user device 14 to activate a text messaging program or application of the user device 14 with a phone number associated with the text button automatically entered in a receiver field as is known in the art. In some embodiments, the call button 166 and the text button 168 may be associated with the seller information for the selected property to allow the user to contact the seller about the selected FSBO real estate listing. In another embodiment, the call button 166 and the text button 168 may be associated with the listing agent information for the selected property to allow the user to contact the listing agent about the selected FSBO real estate listing. In another embodiment, the listing agent or an administrator may determine which information will be associated with the call button 166 and the text button 168 based on the preferences of the seller, the listing agent, or both.

As shown in FIG. 10, the application 27 may be programmed to display the address and associated image of the selected FSBO real estate listing in the address section 170 and the property image 172, respectively, of the listed property screen 54. In one embodiment of the application 27, the FSBO real estate listing may have more than one image associated with it. In such an embodiment, the image button 174 may be programmed to cause the application 27 to send a signal over the network 16 designed to cause the host system 12 to send all of the images associated with the FSBO real estate listing to the application 27 to allow the user to view all of the images associated with the FSBO real estate listing in, for instance, a pop-up screen (not shown).

As shown in FIG. 11, the confirmation screen 56 of the application 27 may be provided with an agent section 180, an active properties section 182, a sale pending section 184, a matched section 186, and a navigation button such as the back button 108. The confirmation screen 56 is designed to allow users to confirm the statuses of properties listed for sale associated with their account to ensure that the properties listed for sale in the system 10 are accurate. It should be noted that the statuses shown in FIG. 11 are for illustration purposes only and should not be construed as limiting. For instance, in some embodiments the confirmation screen 56 may be provided with other statuses for properties listed for sale, or, in some embodiments, the application 27 may be programmed to allow the user to input customized statuses.

The agent section 180 of the confirmation screen 56 is configured to display the name of the agent for whom a list of properties listed for sale is shown in the active properties section 182, the sale pending section 184, and the matched section 186. When a standard user is logged in to the application 27, the agent section 180 will show their name and the properties listed for sale associated with their user account will be listed. If an administrative user is logged in, the application 27 may be programmed to allow the administrative user to change the agent in the agent section 180 to allow the administrative user to view the properties listed for sale associated with different agents. This allows an administrative user to track the activity of all agents.

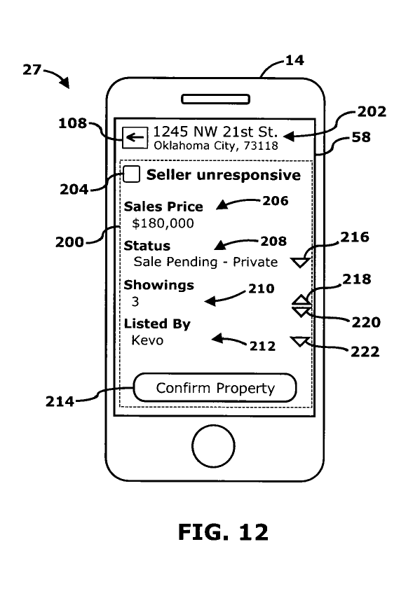

As shown in FIG. 11. each of the properties associated with the real estate agent and/or the real estate agent's real estate agency in the agent section 180 may be presented in a list separated by status. By way of non-limiting example, FIG. 11 shows two (2) active properties in the active property section 182, one (1) property in the sale pending section 184, and one (1) property in the matched section 186 for agent Steve Burris. Each of the properties on the list in each of the sections may be provided with an image 188 of the property, an address section 190, and an view property details button 192. Selecting the view property details button 192 of the confirmation screen 56 causes the application 27 to open the property data screen 58 shown in FIG. 12.

As shown in FIG. 12, the property data screen 58 may be provided with an edit information section 200, a navigation button such as the back button 108, and an address section 202 displaying the address of the property for confirmation.

The edit information section 200 may be provided with fields configured for input by the user such as, for instance, a seller unresponsive field 204, a sales price field 206, a status field 208, a showings field 210, and a listed by field 212. The fields 204-212 of the edit information section 200 allow the user to update and/or confirm the status of the property listed for sale. For instance, if the sales price of a property has been changed, the user may select the sales price field 206 and input the new sales price. The user may indicate the desire to save any changes made or confirm the current information by selecting an appropriately programmed button or mechanism such as a confirm property button 214. Selecting the confirm property button 214 causes the application 27 to send the information input into the fields 204-212 of the edit information section 200 via the network 16 to the host system 12 where the information associated with the property may be updated, for instance, in appropriate fields in the database 32. Once updated, when that property is accessed by users of the system 10, the updated information will be displayed.

The edit information section 200 may also be provided with appropriately programmed buttons such as buttons 216, 218, 220, and 222 that allow the user to perform predetermined activities or access lists. For instance, button 216 may activate a drop-down list of predetermined statuses that may be selected by the user. The statuses may include, but are not limited to, active property, active FSBO, sale pending—private buyer, sale pending—agent buyer, matched pending, matched sold, and pulled off market. In the embodiment shown in FIG. 12, buttons 218 and 220 are an up button and a down button, respectively. Selecting the up button 218, for instance, causes the application 27 to increase the number in the associated field such as the showings field 210 and selecting the down button 220 causes the application 27 to decrease the number in the showings field 210. Button 222 may activate a drop-down list of predetermined listing real estate agencies that indicate which real estate agency has listed the associated property for sale. Selecting the button 222 to activate the drop-down list then selecting a listing real estate agency from the drop-down list will change the information associated with the listed by field 212. It should be noted that in addition to predetermined lists, the drop-down lists may also be provided with another button (not shown) programmed to cause the application 27 to make the associated field (status field 208 or listed by field 212 shown in FIG. 12, for instance) active for input by the user, for instance, using the input device 18 of the user device 14 so that the user may input any desired information.

As shown in FIG. 12, the seller unresponsive field 204 may be provided with a check box to indicate the status. As shown in FIG. 12, the check box has not been selected which may indicate that the seller is currently still responding, for instance, to requests to show their property to potential buyers. Selecting the check box will add an indicator such as a check mark or X designed to indicate a user that the seller is currently unresponsive. This “flags” the property listing in the system 10 to indicate to users that they should be cautious before telling potential buyers that the property is available, for instance.

In some embodiments, the system 10 may be programmed to automatically send a message via text or email to other users associated with the listing agent of that property indicating the status of the property has changed. For instance, the message may indicate the price has changed, the status has changed, or the property has been “flagged”. This way, the system 10 automatically keeps all associated users up-to-date on the current status of properties listed for sale in the system 10.

In one embodiment, the system 10 may be provide with the administrative tool (not shown) which may be, for instance, configured as a web application accessed via the network 16 using a web browser on the user device 14 or the external system 17. The administrative tool may be programmed to allow user administration (i.e. add, delete, modify contact information, etc.), property and/or seller administration (i.e. modify property information, modify contact information, add to a do not call list, modify commission levels, commission overrides and the like), and management reporting.

By way of non-limiting example, management reporting may include 1) a list of which properties have not been confirmed or verified within a predetermined timeframe such as, for instance, weekly for all agents, 2) a list of all new listings added to the system 10 in a predetermined timeframe such as, for instance, since the last listing report, 3) a list of which properties are the most active (i.e. shown, viewed, listing agent is contacted, etc.), or 4) a list of users who are posting new properties.

In the event that an agent leaves or is unable to perform their duties, the administrative tool may be programmed to allow the administrator to reassign a property listed for sale to a different agent/user.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

1. A method, comprising:
establishing communication between at least one host system having a first processor and a database and a first set of instructions stored in non-transitory computer readable memory, and at least one user device having a second processor, an input device, an output device, a communication device, a second set of instructions stored in non-transitory computer readable memory, and a device locator;
the second set of instructions when executed cause the user device to determine a current location of the at least one user device using the device locator and send the current location to the at least one host system;
upon receiving the current location, the first set of instructions causes the host system to access property information from at least one government database, the property information indicative of at least one property associated with the current location and send the property information to the at least one user device;
upon receiving the property information, the second set of instructions causes the at least one user device to provide at least one selectable indicator on the output device of the at least one user device associated with the at least one property; responsive to a first user selecting the indicator associated with the at least one property, the second set of instructions causes the user device to send the first user's selection to the host system; and,
responsive to receiving the first user's selection, the host system creates a new property listing containing the accessed property information and a listing agent information, the listing agent information being user information associated with the first user, the host system storing the new property listing in the database, wherein the new property listing is a for sale by owner (FSBO) property listing;
receiving, at the at least one host system, a request from a second user to view the new property listing;
responsive to receiving the second user's request, the host system searches the database for the new property listing; and
wherein the host system only makes the new property listing available to the second user if the at least one host system determines that the second user is part of a defined group of users associated with the first user.

2. The method of claim 1, wherein an alert is automatically generated and the alert is transmitted to at least one predetermined user of the defined group of users responsive to the new property listing being created.

3. The method of claim 1, further comprising the step of providing at least one field for accepting user input in the new property listing after the new property listing has been created and updating the new property listing after the user has input information in the at least one field.

4. The method of claim 3, further comprising the step of automatically generating an alert and transmitting the alert to at least one predetermined user of the defined group of users responsive to the new property listing being updated.

5. (canceled)

6. (canceled)

7. A system, comprising:
a host system comprising:
a first processor and at least one first non-transitory computer readable medium storing a database and a first set of instructions that when executed by the first processor cause the first processor to obtain property information from at least one government database and record the property information in the database, the property information having parameters indicative of at least one real property;
a user device comprising:
a second processor, an input device, an output device, a communication device, a device locator, and at least one second non-transitory computer readable medium storing a second set of instructions that when executed by the second processor cause the second processor to obtain a current location of the user device using the device locator;
wherein, the second set of instructions cause the user device to send a first signal containing the current location of the user device over a network to the host system;
in response to receiving the current location, the first set of instructions cause the host system to obtain property information associated with the current location of the user device from at least one government database and to generate and transmit a second signal containing the property information associated with the current location to the user device over the network;
in response to receiving the property information, the second set of instructions cause the user device to generate at least one selectable indicator indicative of the property information; and,
responsive to a first user selecting at least one selectable indicator on the user device, the second set of instructions cause the user device to send a third signal containing the property information and user information associated with the first user over the network to the host system, the third signal causing the host system to create and store a new property listing in the database, wherein the new property listing is a for sale by owner (FSBO) property listing; and
wherein, in response to receiving a request to view the new property listing from a second user, the first set of instructions is configured to cause the host system to search the database for the new property listing and make the new property listing available to the second user only if the host system determines that the second user is part of a defined group of users associated with the first user.

8. The system of claim 7, wherein the first set of instructions cause the first processor to generate and transmit an alert, the alert being transmitted to at least one predetermined user of the defined group of users responsive to the new property listing being created.

9. The system of claim 7, further comprising providing at least one field for accepting user input in the new property listing after the new property listing has been created and updating the new property listing after the user has input information in the at least one field.

10. The system of claim 9, wherein the first set of instructions cause the first processor to generate and transmit an alert, the alert being transmitted to at least one predetermined user of the defined group of users responsive to the new property listing being updated.

11. (canceled)

12. (canceled)

13. A system for distributing real estate listings, comprising:
a host system comprising:
a first processor and a non-transitory computer readable storage media storing information indicative of registered users associated with a real estate agency, a database, and a first set of instructions that when executed by the first processor cause the first processor to obtain and record in a database property information, the property information having parameters indicative of at least one real property;
a plurality of user devices, at least one of the user devices being a first user device and at least one of the user devices being a second user device different from the first user device, the plurality of user devices comprising:
a second processor, an input device, an output device, a communication device, a device locator, and at least one second non-transitory computer readable media storing a second set of instructions that when executed by the second processor cause the second processor to obtain a current location of the user device using the device locator;
wherein, the second set of instructions cause the first user device to send a first signal containing the current location of the first user device over a network to the host system;
in response to receiving the current location, the first set of instructions cause the host system to generate and transmit a second signal containing property information associated with the current location to the first user device over the network;
in response to receiving the property information, the second set of instructions cause the first user device to generate at least one selectable indicator indicative of the property information; and,
responsive to a user selecting at least one selectable indicator on the first user device, the second set of instructions cause the first user device to send a third signal containing the property information and user information associated with the user of the first user device over the network to the host system, the third signal causing the host system to create a new property listing and store the new property listing in the database, wherein the new property listing is a for sale by owner (FSBO) property listing; and
in response to generating the new property listing, the first set of instructions cause the host system to disseminate the new property listing over the network to at least one of the second user devices, the second user devices being associated with a defined group of the registered users associated with the real estate agency, the defined group of the registered users being second users.

14. (canceled)

15. (canceled)
